(19) United States
(12) Patent Application Publication
(10) Pub. No.: US 2007/0181824 A1
(43) Pub. Date: Aug. 9, 2007

(54) Radiation image storage panel and method of preparing said panel

(76) Inventors: Jean-Pierre Tahon, Langdorp (BE); Carlo Uyttendaele, Mortsel (BE); Paul Leblans, Kontich (BE)

Correspondence Address: NEXSEN PRUET, LLC, P.O. BOX 10648, GREENVILLE, SC, 29603, US

(21) Appl. No.: 11/650,744

(22) Filed: Jan. 8, 2007

Related U.S. Application Data
(60) Provisional application No. 60/774,095, filed on Feb. 16, 2006.

(30) Foreign Application Priority Data
Feb. 9, 2006 (EP) 06101437.9

(51) Int. Cl. G03B 42/08

(52) U.S. Cl. 250/484.4

(57) ABSTRACT

In a radiation image storage panel, as a layer arrangement of consecutive layers, a support, a sublayer and a stimulable phosphor layer having needle-shaped stimulable phosphor crystals is comprised, said sublayer is a binderless non-vapor deposited layer, at least comprising as a halide compound an inorganic alkali halide salt selected from the group consisting of sodium fluoride, sodium chloride, sodium bromide, potassium fluoride, potassium chloride, potassium bromide, rubidium fluoride, rubidium chloride, rubidium bromide, cesium fluoride, cesium chloride and cesium bromide, thereby providing good adhesiveness between phosphor layer and support.

### CROSS-REFERENCE TO RELATED PATENT APPLICATIONS

This application claims the benefit of U.S. Provisional Application No. 60/774,095 filed Feb. 16, 2006, which is incorporated by reference. In addition, this application claims the benefit of European Application No. 06101437.9 filed Feb. 9, 2006, which is also incorporated by reference.

### FIELD OF THE INVENTION

The present invention is related with a binderless radiation image storage panel provided with a phosphor layer, having improved adhesiveness onto its support.

### BACKGROUND OF THE INVENTION

Radiation image recording systems wherein a radiation image is recorded on a photostimulable phosphor screen by exposing the screen to image-wise modulated penetrating radiation are widely used nowadays.

The recorded image is reproduced by stimulating the exposed photostimulable phosphor screen by means of stimulating radiation and by detecting the light that is emitted by the phosphor screen upon stimulation and converting the detected light into an electrical signal representation of the radiation image.

In several applications e.g. in mammography, sharpness of the image is a very critical parameter. Sharpness of an image that has been read out of a photostimulable phosphor screen depends not only on the sharpness and resolution of the screen itself, but also on the resolution obtained by the read out system which is used.

In conventional read out systems used nowadays a scanning unit of the flying spot type is commonly used. Such a scanning unit comprises a source of stimulating radiation, e.g. a laser light source, means for deflecting light emitted by the laser so as to form a scanning line on the photostimulable phosphor screen and optical means for focusing the laser beam onto the screen.

Examples of such systems are the Agfa Diagnostic Systems, denominated by the trade name ADC 70 and Agfa Compact. In these systems photostimulable phosphor screens are commonly used which comprise a BaFBr:Eu phosphor.

The resolution of the read out apparatus is mainly determined by the spot size of the laser beam. This spot size in its turn depends on the characteristics of the optical light focusing arrangement. It has been recognized that optimizing the resolution of a scanning system may result in loss of optical collection efficiency of the focusing optics. As a consequence an important fraction of the laser light is not focused onto the image screen. A severe prejudice exists against the use of systems having an optical collection efficiency of the focusing optics which is less than 50% because these systems were expected not to deliver an adequate amount of power to the screen in order to read out this screen to a sufficient extent within an acceptable scanning time. A solution has therefor been sought and found as disclosed in EP-A 1 065 523 and corresponding U.S. Pat. No. 6,501,088. Therein use has been made of a method for reading a radiation image that has been stored in a photostimulable phosphor screen comprising the steps of scanning said screen by means of stimulating radiation emitted by a laser source, detecting light emitted by said screen upon stimulation, converting detected light into an electrical signal representation of said radiation image, wherein said photostimulable phosphor screen comprises a divalent europium activated cesium halide phosphor wherein said halide is at least one of chloride and bromide and said laser beam is focused so that the spot diameter of the laser spot emitted by said laser, measured between l/e² points of the gaussian profile of said laser beam is smaller than 100 μm. Object of that invention to provide a method and a system for reading a radiation image that has been stored in a photostimulable phosphor screen was resulting, besides in a method and a system for reading a radiation image stored, in a photostimulable phosphor screen having a needle-shaped storage phosphor layer, and in a method and system yielding a high sharpness.

In US-Application 2004/0149929 a radiation image storage panel has been disclosed, composed of a support, a phosphor matrix compound layer covering a surface of the support at a coverage percentage of 95% or more, and a stimulable phosphor layer (which is composed of multiple prismatic stimulable phosphor crystals standing on the phosphor matrix compound layer) formed on the phosphor matrix compound layer, thereby providing a high peel resistance between the support and the stimulable phosphor layer, a high sensitivity, and a reproduced radiation image of high quality.

However, in a radiation image transformation panel, in order to attain the desired radiation absorbing power the needle shaped europium doped cesium halide storage phosphor must be formed in a layer having a thickness of about 200-800 μm. Since the parent compound of the photostimulable phosphor consisting of an inorganic alkali halide compound, such as CsBr, has a large thermal expansion coefficient of about 50×10⁻⁶/° K, cracks may appear in such a relatively thick layer so that adhesion of the storage phosphor layer onto the support substrate may become a problem, leading to delamination. Factors having a negative influence onto cracking and delamination are related, besides temperature of the substrate and changes thereof during the vapor deposition process, with the pressure of inert gas in the vacuum chamber and with presence of impurities, which have a significant influence upon crystallinity of the deposited phosphor layer during said vapor deposition process. In order to solve that problem, a solution has been proposed in JP-A 2005-156411. In that application a first vapor deposited layer was formed onto the substrate, wherein said layer was containing an inorganic alkali halide compound with a molecular weight smaller than the parent compound of the photostimulable phosphor. The layer with the vapor deposited stimulable europium doped cesium halide phosphor was further deposited thereupon. Nevertheless as a first layer between substrate and storage phosphor layer is a vapor deposited layer again, same problems were met with respect to cracks and delamination and the expected improvement with respect to cracks and delamination was not yet fully obtained.

In U.S. Pat. No. 6,870,167 a process for the preparation of a radiation image storage panel having a phosphor layer which comprises a phosphor comprising a matrix component and an activator component, which comprises the steps of: forming on a substrate a lower prismatic crystalline layer comprising the matrix component by vapor deposition; and forming on the lower prismatic crystalline layer an upper prismatic crystalline layer comprising the matrix component and the activator component by vapor deposition as an arrangement favorable for crystallinity of said upper layer. In favor of adhesion however it has been proposed in US-Application 2005/51736 to make use of spherical shaped phosphors in the lower layer.

When performing vapor deposition techniques in order to prepare phosphor layers onto dedicate substrates, a highly desired substrate material whereupon the scintillator or phosphor material should be deposited is made of glass, a ceramic material, a polymeric material or a metal. As a metal base material use is generally made of flexible metal sheets of aluminum, steel, brass, titanium and copper. Particularly preferred as flexible substrate in the method of the present invention is aluminum as a very good heat-conducting material allowing a perfect homogeneous temperature over the whole substrate. As particularly useful aluminum substrates, without however being limited thereto, brightened anodized aluminum, anodized aluminum with an aluminum mirror and an oxide package and anodized aluminium with a silver mirror and an oxide package available from ALANOD, Germany, are recommended. So as a preferred flexible substrate support an anodized aluminum support layer is recommended. Such an anodized aluminum support layer may have a thickness in the range of from 50 to 500 μm, and more preferably in the range from 200 to 300 μm. Such an anodized aluminum substrate has shown to be particularly favorable indeed with respect to adhesion characteristics with respect to vapor deposited phosphors or scintillators and even bending of that flexible aluminum support coated with a scintillator layer having a thickness of 500 μm up to 1000 μm, does not cause “cracks” or delamination of scintillator or phosphor “flakes”. No problems have indeed been encountered with respect to occurrence of undesirable cracks in the phosphor layer when prepared in a vapor deposition apparatus in optimized conditions.

It should however be noted that, in order to perform vapor deposition of two layers, two different processes in a vapor depositing apparatus are required, at least from a point of view of depositing different raw materials in each layer. Moreover as it is known that increased dopant amounts in the upper layer lead to a desired higher sensitivity of the storage phosphor screen thus formed, it can be expected that higher dopant amounts lead to enhanced cracking and decreased adhesion of the coated layers. Otherwise in order to have better reflection properties in favor of reflection of light emitted upon stimulation of the storage phosphors and, as a consequence thereof, an enhanced sensitivity, it can be expected that a more mirror-like smoother support surface is not in favor of a better adhesion of phosphor layers, deposited thereupon.

### SUMMARY OF THE INVENTION

Therefor it is an object of the present invention to further improve adhesion of the vapor deposited needle-shaped cesium halide phosphor layer. More particularly it is an object of the present invention to take adequate measures in order to avoid cracks, thus improving layer adhesion onto the substrate support, even when introducing higher amounts of dopants in the layers, thereby envisaging a higher sensitivity. Otherwise it is an object of the present invention to improve adhesion between support and phosphor layer, even when making use of smoother supports, providing sensitivity enhancing reflection.

The above-mentioned advantageous effects have been realized by providing a storage phosphor panel having the specific features set out in claim 1. Specific features for preferred embodiments of the invention are set out in the claims dependent thereupon.

Further advantages and embodiments of the present invention will become apparent from the following description.

### DETAILED DESCRIPTION OF THE INVENTION

According to the present invention a radiation image storage panel comprises, as a layer arrangement of consecutive layers, a support, a sublayer and a stimulable phosphor layer comprising needle-shaped stimulable phosphor crystals, wherein that said sublayer is a binderless non-vapor deposited layer, at least comprising an inorganic alkali metal halide salt compound. It has been unexpectedly found that said binderless non-vapor deposited sublayer, comprising as a halide compound an inorganic alkali halide salt selected from the group consisting of sodium fluoride, sodium chloride, sodium bromide, potassium fluoride, potassium chloride, potassium bromide, rubidium fluoride, rubidium chloride, rubidium bromide, cesium fluoride, cesium chloride and cesium bromide, clearly shows an improved adhesiveness of the stimulable phosphor layer.

In a more preferred embodiment according to the present invention said sublayer further comprises a silicium compound. Said silicium compound is an inorganic or an organic compound.

In one embodiment thereof according to the present invention said silicium compound is an inorganic colloidal silica. Suitable colloidal silica sol compounds are commercially available, such as the “Syton” silica sols (a trademarked product of Monsanto Inorganic Chemicals Div.), the “Ludox” silica sols (a trademarked product of du Pont de Nemours & Co., Inc.), the “Nalco” and “Nalcoag” silica sols (trademarked products of Nalco Chemical Co), the “Snowtex” silica sols of Nissan Kagaku K.K. and the “Kieselsol, Types 100, 200, 300, 500 and 600” (trademarked products of Bayer AG). Especially colloidal silicas having a specific surface area between 100 and 600 m²/g are preferred.

In another embodiment an organic silicium compound is used, as e.g. siloxanes, silazanes and siloxazanes as an oligomeric or polymeric structure.

According to the present invention, said inorganic alkali metal halide salt compound in said sublayer is selected from the group consisting of sodium fluoride, sodium chloride, sodium bromide, potassium fluoride, potassium chloride, potassium bromide, rubidium fluoride, rubidium chloride, rubidium bromide, cesium fluoride, cesium chloride and cesium bromide. Although fluoride compounds show an even better corrosion resistance than other halide compounds, especially the said other halide compounds provide improved adhesive strength, in that in tape adhesion tests, when a tape is adhered onto the storage phosphor layer of a panel, no breakage is observed between said storage phosphor layer and said sublayer or between said sublayer and said panel support.

According to the present invention, said stimulable phosphor layer comprises needle-shaped phosphor crystals having an alkali metal halide as a matrix or base compound and a lanthanide as an activator or dopant compound.

In a particular embodiment according to the present invention, said needle-shaped stimulable phosphor is a CsBr:Eu phosphor. CsBr:Eu especially selected from a viewpoint of high sensitivity and high sharpness, is advantageously provided with amounts of Eu as an activator or dopant, in the range from 0.0001 to 0.01 mole/mole of CsBr, and more preferably from 0.0003 to 0.005 mole/mole. In the case of a stimulable CsBr:Eu phosphor, the europium compound of the evaporation source may start from a divalent europium Eu²⁺ compound and a trivalent Eu³⁺ compound, wherein said europium compound may be EuBrₓ in which x satisfies the condition of 2.0≦x≦2.3, wherein a europium compound containing the divalent europium compound as much as possible, i.e. at least 70%, is desired.

Although the thickness of the phosphor layer changes with the sensitivity class of the photostimulable phosphor, it is desirable to deposit a phosphor layer having a thickness from 100 μm to 1000 μm, more preferable from 200 μm to 800 μm, and still more preferable from 300 μm-700 μm. Too thin a phosphor layer causes too little absorbed amounts of radiation, an increased transparency, and a deteriorated image quality of the obtained radiation image, whereas too thick a phosphor layer will cause image quality to decrease, due to a lowered sharpness.

In a further particular embodiment according to the present invention, said matrix compound and said halide compound have same composition. For a CsBr:Eu phosphor, a sublayer having a bromide salt as a halide salt will be preferred in that case. Especially desired with respect to the sublayer is a low radiation absorbing power, and also, when radiation exposure is from the rear side of a substrate, i.e. from the side opposite to the phosphor layer side at the radiation image transformation panel, attenuation of a radiation will be low when use is made of potassium bromide as a bromide salt.

According to the present invention, a method of preparing a radiation image storage panel is further offered, wherein said binderless non-vapor deposited sublayer is coated from a solution by means of a coating technique selected from the group consisting of dip-coating, bar-coating, roller-coating and knife-coating, followed by drying. Coatings are made from aqueous or non-aqueous solutions or from mixtures of aqueous and non-aqueous solutions. In the case of purely aqueous solutions, an alkali metall halide salt concentration of at least 0.1 M is preferred, depending on the solubility of said alkali metal halide salt in aqueous solutions, which depends on temperature. It is recommended to perform drying in a way in order to get a layer, homogeneous in thickness. An average thickness of a sublayer is e.g. in the range from 0.05 μm to 10 μm, and more preferably in the range from 0.5 μm to 5 μm. Outside these ranges, for a thinner sublayer no improved adhesiveness will be attained as envisaged, whereas for a thicker sublayer an undesirable radiation absorption effect may occur as well as an increased risk for loss in adhesion again. Variations in thickness of the sublayer should be in the range from at most 10%, and, more preferably, at most 5%. It is moreover recommended to control the drying step or drying conditions in such a way that micro-structures at the surface should not result in too high a roughness at the surface. An average roughness calculated after having measured with a perth-o-meter at least at 10 points at said surface should e.g. not exceed a value of 5 μm, more particularly a value of 3 μm, and even not a value of 1 μm.

In a method of preparing a radiation image storage panel according to the present invention, said phosphor layer is a binderless phosphor layer, coated onto the sublayer by a technique selected from the group consisting of physical vapor deposition, chemical vapor deposition and an atomization technique. As an atomization technique, electron beam vaporization can be used, as has e.g. been described in U.S. Pat. Nos. 6,740,897 and 6,875,990 and in US-Applications 2002/050570, 2004/075062 and 2004/149931, the contents of all of which is incorporated herein by reference. In the electron beam evaporation technique, an electron beam generated by an electron gun is applied onto the evaporation source and an accelerating voltage of electron beam preferably is in the range of 1.5 kV to 5.0 kV. By applying the electron beam, the evaporation source of matrix component and activator element is heated, vaporized, and deposited on the substrate. Physical vapor deposition techniques as suitable for use in the deposition of binderless needle-shaped crystals in the phosphor layer of the present invention, such as resistive heating, sputtering and RF induction techniques. Resistive heating vacuum deposition, may advantageously be applied as has been described e.g. in U.S. Pat. Nos. 6,720,026; 6,730,243 and 6,802,991 and in US-Application 2001/007352, the contents of all of which is incorporated herein by reference. This technique is recommended as a method in order to vapor deposit the needle-shaped binderless storage phosphors for a panel according to the present invention. In the resistance heating evaporation, the evaporation sources are heated by supplying electric energy to the resistance heating means: crucible or boat configurations—preferably composed of refractory materials—in a vapor deposition apparatus, in order to practically realize a homogeneous deposit of vapor deposited phosphor material may be applied as has e.g. been disclosed in US-Applications 2005/000411, 2005/000447 and 2005/217567, the contents of all of which is incorporated herein by reference.

Vapor deposition in a vacuum deposition apparatus requires adjustment of a predetermined degree of vacuum. For a binderless needle-shaped storage phosphor layer in a panel according to the present invention, forming said phosphor under a high vacuum is desirable: the degree of vacuum of 1×10⁻⁵ to 5 Pa, and, more specifically, from 1×10⁻² to 2 Pa is desired, wherein an inert gas, such as an Ar or Ne noble gas, or alternatively, nitrogen gas, may be introduced into the vacuum deposition apparatus. Evacuation to give an even lower inner pressure of 1×10⁻⁵ to 1×10⁻² Pa is more preferred for electron beam evaporation. Introduction of oxygen or hydrogen gas may be advantageously performed, more particularly in order to enhance reactivity and/or e.g. in an annealing step. Introduction of an inert gas can moreover be performed in favor of cooling the vapor stream before deposition onto the substrate and/or the substrate, whereupon phosphor vapor raw materials should be deposited. The deposition rate generally is in the range of 0.1 to 1,000 μm/min., preferably in the range of 1 to 100 μm/min. It is not excluded to perform a pretreatment to the support, coated with the sublayer as in the present invention: in favor of an enforced drying step, the layer arrangement before phosphor deposition is held at a high temperature during a defined time. It is even not excluded to increase the percentage of relative humidity until the surface of the sublayer starts hydrating, in order to get a smooth base for the phosphor layer. Efficient deposition of the storage phosphor layer onto the substrate however, requires temperatures for the substrate in the range from 50° C. to 250° C. as has been disclosed in US-Application 2004/081750, the contents of which is incorporated herein by reference. Heating or cooling the substrate during the deposition process can be steered and controlled as required.

Phosphor raw materials comprising matrix and activator compounds are advantageously present as precursors in form of powders or tablets. Examples of phosphor precursor materials useful in the context of the present invention have been described in US-Applications 2005/184250, 2005/184271 and 2005/186,329, the contents of all of which is incorporated herein by reference. Evaporation may be performed from one or more crucibles. In the presence of more than one crucible, an independent vaporization control may be performed in favor of uniformity, homogeneity and/or dedicated incorporation of activator or dopant. This is more particularly preferred when differences in vapor pressure between matrix and activator compound are significant.

The formed phosphor layer comprises prismatic, needle-shaped stimulable phosphor crystals which are aligned almost perpendicularly to the substrate. The thus formed phosphor layer only comprises the stimulable phosphor, without presence of a binder, and there are produced cracks extending the depth direction in the phosphor layer. In favor of image quality, especially sharpness, the needle-shaped phosphor layer may advantageously be colored with a colorant which does not absorb the stimulated emission but the stimulating rays as has e.g. been described in U.S. Pat. No. 6,977,385, the contents of which is incorporated herein by reference.

The layer arrangement as disclosed in the present invention may further be protected with a protective layer at the side of the needle-shaped binderless phosphor layer. A transparent protective film on the surface of the stimulable phosphor layer is advantageously applied in order to ensure good handling of the radiation image storage panel in transportation steps and in order to avoid deterioration and damaging. Chemically stable, physically strong, and high moisture proof coatings may be provided by coating the stimulable phosphor film with a solution in which an organic polymer (e.g., cellulose derivatives, polymethyl methacrylate, fluororesins soluble in organic solvents) is dissolved in a solvent, by placing a sheet, prepared beforehand, for the protective film (e.g., a film of organic polymer such as polyethylene terephthalate, a transparent glass plate) on the phosphor film with an adhesive, or by depositing vapor of inorganic compounds on the phosphor film. Protective layers may thus be composed of materials such as a cellulose acetate, nitrocellulose, polymethylmethacrylate, polyvinyl-butyral, polyvinyl-formal, polycarbonate, polyester, polyethylene terephthalate, polyethylene, polyvinylidene chloride, nylon, polytetrafluoroethylene and tetrafluoroethylene-6 fluoride propylene copolymer, a vinylidene-chloride-vinyl chloride copolymer, and a vinylidene-chloride-acrylonitrile copolymer. A transparent glass support may also be used as a protective layer. Moreover, by vacuum deposition, making use e.g. of the sputtering technique, a protective layer of SiC, SiO₂, SiN, and Al₂O₃ grade may be formed. Various additives may be dispersed in the protective film. Examples of the additives include light-scattering fine particles (e.g., particles of magnesium oxide, zinc oxide, titanium dioxide and alumina), a slipping agent (e.g., powders of perfluoro-olefin resin and silicone resin) and a crosslinking agent (e.g., polyisocyanate). Preferred thicknesses of protective layers are in the range from 1 μm up to 20 μm for polymer coatings and even up to 2000 μm in case of inorganic materials as e.g. silicate glass. For enhancing the resistance to stain, a fluororesin layer is preferably provided on the protective film. The fluororesin layer can be formed by coating the surface of the protective film with a solution in which a fluororesin is dissolved or dispersed in an organic solvent, and drying the coated solution. The fluororesin may be used singly, but a mixture of the fluororesin and a film-forming resin can be employed. In the mixture, an oligomer having polysiloxane structure or perfluoroalkyl group can be further added. In the fluororesin layer, fine particle filler may be incorporated to reduce blotches caused by interference and to improve the quality of the resultant image. The thickness of the fluororesin layer is generally in the range of 0.5 to 20 μm. For forming the fluororesin layer, additives such as a crosslinking agent, a film-hardening agent and an anti-yellowing agent can be used. In particular, the crosslinking agent is advantageously employed to improve durability of the fluororesin layer.

### EXAMPLES

While the present invention will hereinafter be described in connection with preferred embodiments thereof, it will be understood that it is not intended to limit the invention to those embodiments.

As a support material use was made of aluminum P51 from AGFA having “lithographic quality”, i.e. normally used for making lithographic plates as Lithostar® or Azura®, trade name products from Agfa-Gevaert, Mortsel, Belgium.

Matrix compound layers were coated from aqueous CsBr solutions, differing in concentration (expressed in g of CsBr per liter) giving rise afterwards to matrix compound layers having different amounts of CsBr-salt, and wherein, as coating aids, F₃—(CF₂)₆—CO—NH—(CH₂—CH₂—O)₁₇₋₂₀—H, from Agfa, Mortsel, Belgium, was added as a surfactant to the aqueous CsBr or CsF solution in a concentration, varying in a range from 3-30% by weight (i.e. 3.8% for plate 410; 9.5% for plate 411; 13.3% for plates 404 and 409 and 28.8% for plates 406 and 407) together with fine silica particles (average particle size: 6 nm) LEVASIL 500, from HC STARCK, Germany, in coatings in an amount as indicated in the Table 1 hereinafter.

The aqueous layers were coated by knife-coating at a layer thickness of 25 μm and dried in an oven at 50° C. during 1 hour. In a comparative example no matrix compound sublayer was coated.

A CsBr:Eu photostimulable phosphor screen was prepared on the flexible anodized aluminum plate, coated with the dried sublayer (except for the comparative sample plate), in a vacuum chamber by means of a thermal vapor deposition process, starting from a mixture of CsBr and EuOBr as raw materials. Said deposition process onto said flexible anodized aluminum support was performed in such a way that said support was rotating over the vapor stream. An electrically heated oven and a refractory tray or boat were used, in which 160-200 g of a mixture of CsBr and EuOBr as raw materials in a 99.5%/0.5% CsBr/EuOBr percentage ratio by weight were present as raw materials to become vaporized.

As a crucible an elongated boat having a length of 100 mm was used, having a width of 35 mm and a side wall height of 45 mm composed of “tantalum” having a thickness of 0.5 mm, composed of 3 integrated parts: a crucible container, a “second” plate with slits and small openings and a cover with slit outlet. The longitudinal parts were fold from one continuous tantalum base plate in order to overcome leakage and the head parts are welded. Said second plate was mounted internally in the crucible at a distance from the outermost cover plate which was less than ⅔ of said side wall height of 45 mm. Under vacuum pressure (a pressure of 2×10⁻¹ Pa equivalent with 2×10⁻³ mbar) maintained by a continuous inlet of argon gas into the vacuum chamber, and at a sufficiently high temperature of the vapor source (760° C.) and the chimney the obtained vapor was directed towards the moving sheet support and was deposited thereupon successively while said support was rotating over the vapor stream. Said temperature of the vapor source was measured by means of thermocouples present outside and pressed under the bottom of said crucible and by tantalum protected thermocouples present in the crucible and in the chimney.

The (sublayer coated) anodized aluminum support having a thickness of 280 μm, a width of 10 cm and a length of 10 cm, was positioned at the side whereupon the phosphor should be deposited at a distance of 22 cm between substrate and crucible vapor outlet slit.

Plates were taken out of the vapor deposition apparatus after having run same vapor deposition times, leading to phosphor plates having phosphor layers of equal thicknesses.

For each of the matrix compound layers, besides amounts of CsBr-salt in the matrix compound layer, amounts of silica in the same layer have been given. For the Eu-doped phosphor layers coated thereupon by vapor deposition, coated weight amounts of the phosphor have been summarized, as well as relative speed figures (in SAL %).

No protective sheet was further coated as adhesive strength of the phosphor layer onto the sublayer should be tested.

The data mentioned above have been set out in the Table 1, wherein relative speed (SAL %) is defined as the speed of each of the screens compared with the reference speed of an MD10® reference photostimulable phosphor screen manufactured by Agfa-Gevaert, Mortsel, Belgium.

Adhesion of the layers was tested by a “tape adhesion test”, wherein relative figures were given after having performed said test wherein a tape was adhered to the phosphor layer and teared off in order to control the effect upon adhesion between phosphor layer and support: “3” was related with “critical” adhesion of the reference plate (not completely satisfying—causing adhesion problems more than once), “2” indicative for a “better” adhesion (acceptable, occasionally—rarely—showing an adhesion problem) and “1” being indicative for “good” adhesion (no delamination ever observed between support and phosphor layer while tearing off the tape).

TABLE 1

| | | | Silica | | | |
|---|---|---|---|---|---|---|
| | CsBr | CsF | coating | CsBr:Eu | Adhe- | |
| No. | matrix | matrix | weight | phosphor | sion | |
| CB- | layer | layer | (wt % vs. | layer | Test | SAL |
| plate | (mg/cm²) | (mg/cm²) | CsBr) | (mg/cm²) | Figure | % |
| 73405 | 0 | 0 | 0 | 48.6 | 3 | 190 |
| 73404 | 0.37 | 0 | 0 | 39.8 | 2 | 225 |
| 73406 | 0.80 | 0 | 0 | 48.5 | 2 | 240 |
| 73407 | 0.80 | 0 | 10 | 48.0 | 1 | 231 |
| 73409 | 0.37 | 0 | 10 | 47.4 | 1 | 215 |
| 73410 | 0.10 | 0 | 10 | 47.1 | 1 | 210 |
| 73411 | 0 | 0.37 | 0 | 47.8 | 3 | 230 |

It is clear from the data given in Table 1 that presence of a matrix compound sublayer, coated from an aqueous solution of CsBr as matrix compound salt, provides an increased speed (see higher SAL % values). Moreover, apart for the comparative coating (CB-plate 73405), the inventive coatings provide a better, at least acceptable adhesion onto the aluminum substrate. Within the inventive phosphor plates having been prepared with a vapor deposited phosphor layer onto a dried aqueous sublayer coating of CsBr matrix compound salt, those having silica particles in the dried sublayer moreover provide a further improved adhesion of the layers coated onto the aluminum support.

Having described in detail preferred embodiments of the current invention, it will now be apparent to those skilled in the art that numerous modifications can be made therein without departing from the scope of the invention as defined in the appending claims.

What is claimed is:

1. A radiation image storage panel comprising as a layer arrangement of consecutive layers: a support, a sublayer and a stimulable phosphor layer comprising needle-shaped stimulable phosphor crystals, wherein said sublayer is a binderless non-vapor deposited layer, at least comprising as halide compound an inorganic alkali halide salt selected from the group consisting of sodium fluoride, sodium chloride, sodium bromide, potassium fluoride, potassium chloride, potassium bromide, rubidium fluoride, rubidium chloride, rubidium bromide, cesium fluoride, cesium chloride and cesium bromide.

2. Panel according to claim 1, wherein said sublayer further comprises a silicium compound.

3. Panel according to claim 1, wherein said stimulable phosphor layer comprises needle-shaped phosphor crystals having an alkali metal halide salt as a matrix compound and a lanthanide as an activator.

4. Panel according to claim 2, wherein said stimulable phosphor layer comprises needle-shaped phosphor crystals having an alkali metal halide salt as a matrix compound and a lanthanide as an activator.

5. Panel according to claim 3, wherein said matrix compound and said alkali metal halide salt compound have the same composition.

6. Panel according to claim 4, wherein said matrix compound and said alkali metal halide salt compound have the same composition.

7. Panel according to claim 1, wherein said needle-shaped stimulable phosphor is a CsBr:Eu phosphor.

8. Panel according to claim 2, wherein said needle-shaped stimulable phosphor is a CsBr:Eu phosphor.

9. Panel according to claim 3, wherein said needle-shaped stimulable phosphor is a CsBr:Eu phosphor.

10. Panel according to claim 5, wherein said needle-shaped stimulable phosphor is a CsBr:Eu phosphor.

11. Method of preparing a radiation image storage panel according to claim 1, wherein said binderless non-vapor deposited sublayer is coated from a solution by means of a coating technique selected from the group consisting of dip-coating, bar-coating, roller-coating and knife-coating, followed by drying.

12. Method of preparing a radiation image storage panel according to claim 2, wherein said binderless non-vapor deposited sublayer is coated from a solution by means of a coating technique selected from the group consisting of dip-coating, bar-coating, roller-coating and knife-coating, followed by drying.

13. Method of preparing a radiation image storage panel according to claim 3, wherein said binderless non-vapor deposited sublayer is coated from a solution by means of a coating technique selected from the group consisting of dip-coating, bar-coating, roller-coating and knife-coating, followed by drying.

14. Method of preparing a radiation image storage panel according to claim 5, wherein said binderless non-vapor deposited sublayer is coated from a solution by means of a coating technique selected from the group consisting of dip-coating, bar-coating, roller-coating and knife-coating, followed by drying.

15. Method of preparing a radiation image storage panel according to claim 7, wherein said binderless non-vapor deposited sublayer is coated from a solution by means of a coating technique selected from the group consisting of dip-coating, bar-coating, roller-coating and knife-coating, followed by drying.

16. Method of preparing a radiation image storage panel according to claim 1, wherein said phosphor layer is a binderless phosphor layer, coated by a technique selected from the group consisting of physical vapor deposition, chemical vapor deposition and an atomization technique.

17. Method of preparing a radiation image storage panel according to claim 2, wherein said phosphor layer is a binderless phosphor layer, coated by a technique selected from the group consisting of physical vapor deposition, chemical vapor deposition and an atomization technique.

18. Method of preparing a radiation image storage panel according to claim 3, wherein said phosphor layer is a binderless phosphor layer, coated by a technique selected from the group consisting of physical vapor deposition, chemical vapor deposition and an atomization technique.

19. Method of preparing a radiation image storage panel according to claim 5, wherein said phosphor layer is a binderless phosphor layer, coated by a technique selected from the group consisting of physical vapor deposition, chemical vapor deposition and an atomization technique.

20. Method of preparing a radiation image storage panel according to claim 7, wherein said phosphor layer is a binderless phosphor layer, coated by a technique selected from the group consisting of physical vapor deposition, chemical vapor deposition and an atomization technique.
